(19) United States
(12) Patent Application Publication
(10) Pub. No.: US 2010/0223330 A1
(43) Pub. Date: Sep. 2, 2010

(54) METHOD AND APPARATUS FOR PROVIDING USER INFORMATION

(75) Inventor: Yafeng ZHANG, Shenzhen (CN)

Correspondence Address: FutureWei Technologies, Inc.;IPR & Standards Department, 1700 Alma Drive, Suite 500, Plano, TX, 75075, US

(73) Assignee: HUAWEI TECHNOLOGIES CO., LTD., Shenzhen (CN)

(21) Appl. No.: 12/777,337

(22) Filed: May 11, 2010

Related U.S. Application Data
(63) Continuation of application No. PCT/CN2008/073083, filed on Nov. 17, 2008.

(30) Foreign Application Priority Data
Nov. 16, 2007 (CN) 200710188305.X

(51) Int. Cl. G06F 15/16

(52) U.S. Cl. 709/203

(57) ABSTRACT

A method for providing local user information is provided, which includes the following steps. A request for user information is acquired from an application server (AS). According to information for identifying a terminal and provided by the AS and a prerecorded associating relationship between the information for identifying the terminal and the user information, user information associated with the information for identifying the terminal is queried. The queried user information is provided for the AS. An apparatus for providing local user information, a method and an apparatus for providing roaming user information are also provided.

### CROSS-REFERENCE TO RELATED APPLICATIONS

This application is a continuation of International Application No. PCT/CN PCT/CN2008/073083, filed on Nov. 17, 2008, which claims priority to Chinese Patent Application No. 200710188305.X, filed on Nov. 16, 2007, both of which are hereby incorporated by reference in their entireties.

### FIELD OF THE TECHNOLOGY

The present invention relates to the wireless communication technology, and more particularly to the technology of providing user information.

### BACKGROUND OF THE INVENTION

With the gradual maturation of the third generation (3G) technologies, users demand richer and more varied services. In order to satisfy the demands of the users, various types of application server (AS) have been developed and provided currently. When a user demands services, an AS needs to query user information according to an Internet Protocol (IP) address of the user in a data packet, so as to determine whether the user can use the service according to the user information.

At present, it is commonly believed that a Wireless Application Protocol gateway (WAP GW) is used to provide an AS with the function of querying user information according to an IP address of a user. FIG. 1 is a schematic view of a scheme of providing user information in current WAP services. As shown in FIG. 1, when user equipment (UE) accesses (steps 1 and 2), a Radius server needs to copy an accounting message to the WAP GW (step 3). The WAP GW obtains user information associated with the IP address of the user according to a Radius accounting message. When the user requests services from the AS (steps 4 to 6), the AS queries the user information from the WAP GW according to the IP address of the user (step 7).

In the implementation of the present invention, the inventor finds that if the WAP GW provides the AS with the function of querying user information according to the IP address of the user, the Radius server needs to provide the Radius accounting message for the WAP GW. As the original Radius accounting message carries limited information, the Radius server further needs to add extra information in the original Radius accounting message. As can be seen, the implementation of the Radius server is very complicated. In addition, the WAP GW needs to receive and resolve the Radius accounting message, so as to obtain the user information associated with the IP address of the user. However, the original functions of the WAP GW do not include the functions of receiving and resolving the Radius accounting message, so the implementation of the WAP GW is also very complicated. Therefore, it is very complicated to realize the current scheme of providing user information, thus resulting in increases of development cost.

### SUMMARY OF THE INVENTION

The present invention is directed to a method and an apparatus for providing user information, so as to reduce the complexity of providing user information, thereby decreasing development cost.

In order to solve the foregoing technical problems, the present invention provides a method for providing local user information, which includes the following steps. A request for user information is acquired from an application server (AS). According to information for identifying a terminal and provided by the AS and a prerecorded associating relationship between the information for identifying the terminal and the user information, the user information associated with the information for identifying the terminal is queried. The queried user information is provided for the AS.

The present invention further provides an apparatus for providing local user information, which includes a recording unit, a request acquiring unit, a querying unit, and a providing unit. The recording unit is adapted to record an associating relationship between information for identifying a terminal and user information. The request acquiring unit is adapted to acquire a request for user information from an AS. The querying unit is adapted to query, after the request acquiring unit acquires the request, the user information associated with the information for identifying the terminal, according to the information for identifying the terminal and provided by the AS, and the associating relationship, recorded by the recording unit, between the information for identifying the terminal and the user information. The providing unit is adapted to provide the user information queried by the querying unit for the AS.

The present invention further provides a method for providing roaming user information, which includes the following steps. A request for user information is acquired from an AS. According to information for identifying a terminal and provided by the AS and a prerecorded associating relationship between the information for identifying the terminal and a network access identifier (NAI), a home Radius server of the terminal is searched and user information associated with the information for identifying the terminal and provided by the home Radius server is acquired. The queried user information is provided for the AS.

The present invention further provides an apparatus for providing roaming user information, which includes a recording unit, a request acquiring unit, a querying unit, a user information acquiring unit, and a user information providing unit. The recording unit is adapted to record an associating relationship between information for identifying a terminal and an NAI. The request acquiring unit is adapted to acquire a request for user information from an AS. The querying unit is adapted to search a home Radius server of the terminal according to information for identifying the terminal and provided by the AS and the associating relationship, recorded by the recording unit, between the information for identifying the terminal and the NAI. The user information acquiring unit is adapted to acquire user information, which is associated with the information for identifying the terminal, provided by the home Radius server and queried by the querying unit. The associating relationship between the information for identifying the terminal and the user information is recorded by the home Radius server according to a Radius authorization message and a Radius accounting message. The user information providing unit is adapted to provide the user information acquired by the user information acquiring unit for the AS.

In the embodiment of providing local user information according to the present invention, no matter whether the service used by the terminal is the Wireless Application Protocol (WAP) service or not, the AS may request the Radius server to acquire user information directly. The Radius server may also provide user information for the Radius server directly. The WAP GW is not needed for the requesting and providing, so the complexity of providing user information is reduced, thereby decreasing the development cost.

In the embodiment of providing roaming user information according to the present invention, no matter whether the service used by the terminal is the WAP service or not, the AS may request acquiring user information from the roaming Radius server directly. The roaming Radius server may request acquiring user information from the home Radius server directly. The home Radius server may provide user information for the roaming Radius server directly. The roaming Radius server may provide user information for the AS directly. The WAP GW is not needed for the requesting and providing, so the complexity of providing user information is reduced, thereby decreasing the development cost. At the same time, it is also realized that the roaming Radius server provides user information for the AS when the roaming terminal uses services.

### BRIEF DESCRIPTION OF THE DRAWINGS

FIG. 1 is a schematic view of a scheme of providing user information in current WAP services;

FIG. 2 is a schematic view of a scheme of providing local user information according to an embodiment of the present invention;

FIG. 3 is a schematic view of a scheme of providing roaming user information according to an embodiment of the present invention;

FIG. 4 is a flow chart of a first embodiment according to an embodiment of the present invention;

FIG. 5 is a flow chart of a second embodiment according to an embodiment of the present invention;

FIG. 6 is a flow chart of a third embodiment according to an embodiment of the present invention; and

FIG. 7 is a flow chart of a fourth embodiment according to an embodiment of the present invention.

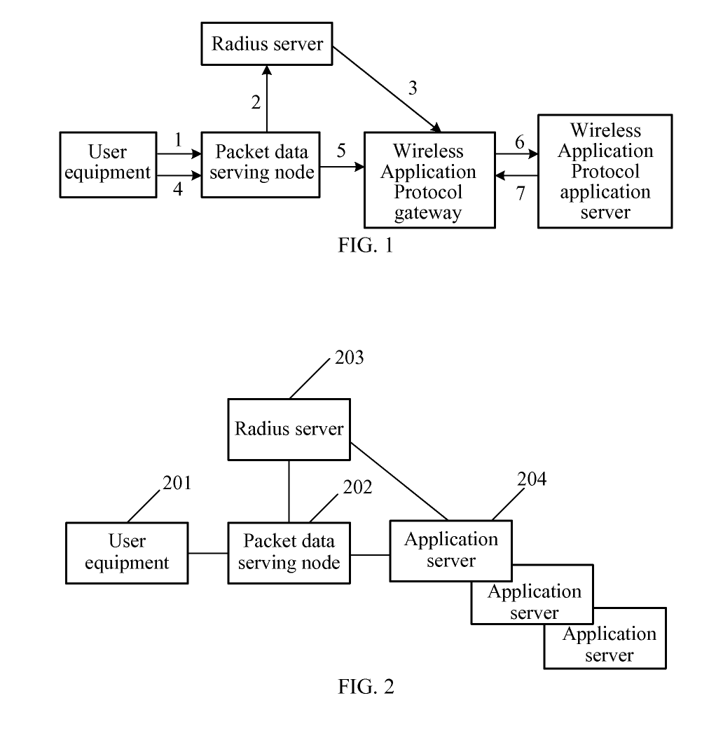

### DETAILED DESCRIPTION OF THE EMBODIMENTS

The overall technical solutions of the method and apparatus according to embodiments of the present invention are illustrated in the following.

The present invention provides a method for providing local user information, which includes the following steps. In a process when a terminal accesses a network, information for identifying the terminal is acquired and an associating relationship between the information for identifying the terminal and user information is recorded. When a request for user information from an application server (AS) is acquired, according to the information for identifying the terminal and provided by the AS and the recorded associating relationship between the information for identifying the terminal and the user information, user information associated with the information for identifying the terminal is queried. The queried user information is provided for the AS.

The process for the terminal accessing the network means processes of authorization and authentication between the terminal and the network in the embodiment, for example, Radius authorization, authentication, and accounting (AAA) processes. The information for identifying the terminal may be an Internet Protocol (IP) address of the terminal. If the implementation environment permits, an identifier of the terminal may also be used as the information for identifying the terminal. The user information may include user information acquired in the registration process of the terminal and user information acquired in the process when the terminal accesses the network. The terminal may be user equipment (UE).

As shown in FIG. 2, a user-information querying interface may be disposed between a Radius server 203 and a plurality of ASs 204. The used bearer protocol may be a Diameter Protocol or Hypertext Transfer Protocol (HTTP). Of course, the bearer protocol may also be other applicable protocols. The plurality of ASs 204 is connected to a packet data serving node (PDSN) 202 directly.

When UE 201 accesses through the PDSN, the Radius server 203 records an associating relationship between an IP address of the UE 201 and the user information. Particularly, the Radius accounting message does not need to be provided for equipment such as a Wireless Application Protocol gateway (WAP GW) (not shown). When the UE 201 sends a data packet to an AS 204, the AS 204 request the Radius server 203 to provide user information through the user-information querying interface between the AS 204 and the Radius server 203. The Radius server 203 queries user information corresponding to the IP address, according to the IP address of the UE 201 and provided by the AS 204, and provides the user information for the AS 204.

The Radius server 203 may first acquire a part of the user information through a registration process with the UE 201. The Radius server 203 may acquire another part of user information through a Radius AAA process with the UE 201; specifically, the Radius server 203 may acquire the user information from the acquired Radius accounting message reported by the UE 201. The user information may include a number of the UE 201. If the UE 201 is a mobile phone, the number of the UE 201 is a mobile phone number.

In the foregoing method embodiment, if the UE 201 uses WAP services, a data packet sent by the UE 201 to the AS 204 can pass the WAP GW (not shown) between the PDSN 202 and the AS 204.

In the foregoing method embodiments, when the AS 204 requests the Radius server 203 to provide the user information, the AS 204 may request required information. Specifically, a request message is used, and main properties of the request message are as shown in Table 1.

TABLE 1

| Property | | Length | | |
|---|---|---|---|---|
| Name | Type | (Byte) | Description | Value Rules |
| IP | String | 8 . . . 39 | The IP | If it is an IP version 4 |
| address | | | address | (IPv4) address, the form |
| | | | of the | is: |
| | | | terminal. | x.x.x.x |
| | | | | If it is an IP version 6 |
| | | | | (IPv6) address, the form |
| | | | | is: |
| | | | | y.y.y.y.y.y:x.x.x.x |

When the Radius server 203 provides the user information for the AS 204, the information required by the AS 204 is provided. Specifically, a response message is used, and main properties of the response message are as shown in Table 2.

TABLE 2

| Property | | Length | | |
|---|---|---|---|---|
| Name | Type | (Byte) | Description | Value Rules |
| NasIPAddress | String | 8 . . . 39 | The IP address of the access | If it is an IPv4 |
| | | | equipment (the access equipment | address, the form is: |
| | | | is the PDSN in Network C) | x.x.x.x |
| | | | | If it is an IPv6 |
| | | | | address, the form is: |
| | | | | y.y.y.y.y.y:x.x.x.x |
| MSISDN | String | 3 . . . 30 | Mobile phone number | |
| IMSI | String | 0 . . . 30 | International Mobile Subscriber | |
| | | | Identity | |
| NAI | String | 0 . . . 64 | Network access identifier | |

The information listed in Table 2 is commonly used user information. If necessary in practice, other user information may be added into Table 2.

The method for providing local user information may be implemented by apparatuses of various forms. One apparatus for providing local user information includes an information acquiring unit, a recording unit, a request acquiring unit, a querying unit, and a providing unit. The information acquiring unit is adapted to acquire information for identifying a terminal in a process when the terminal accesses a network. The recording unit is adapted to record an associating relationship between the user information and the information, acquired by the information acquiring unit, for identifying the terminal. The request acquiring unit is adapted to acquire a request for user information from an AS. The querying unit is adapted to query, after the request acquiring unit acquires the request, user information associated with the information for identifying the terminal, according to the information for identifying the terminal and provided by the AS, and the associating relationship between the information for identifying the terminal and the user information recorded in the recording unit. The providing unit is adapted to provide the user information queried by the querying unit for the AS. The process that the terminal accesses the network here means processes such as authorization and authentication between the terminal and the network, for example, a Radius AAA process. The information for identifying the terminal may be an IP address of the terminal. Of course, if the implementation environment permits, an identifier of the terminal can be used as the information for identifying the terminal. The user information may include user information acquired in a registration process of the terminal and the user information acquired in the process when the terminal accesses the network. The terminal may be a UE.

The apparatus may include a registering unit. The registering unit is adapted to register with the terminal and acquire a part of user information through the registration. The part of the user information may be provided for the recording unit if the recording unit needs. The information acquiring unit may acquire another part of the user information in the process when the terminal accesses the network. Specifically, the user information may be acquired from the acquired Radius accounting message reported by the terminal. The user information can include a number of the UE. If the UE is a mobile phone, the number of the UE is a mobile phone number.

Before the request acquiring unit acquires the request for the user information from the AS, the UE may send a data packet to the AS. If the UE uses the WAP service, the data packet sent by the UE to the AS passes through the WAP GW between the PDSN and the AS; otherwise, the data packet does not need to pass through the WAP GW.

A user-information querying interface is disposed between the request acquiring unit and the AS. A bearer protocol used by the interface may be the Diameter Protocol or the HTTP Protocol. Of course, the bearer protocol may also be other applicable protocols. The request acquired by the request acquiring unit may be a request message, and may also be a request from the AS for required information. Main properties of the request message may be as shown in Table 1. When the providing unit provides the user information for the AS, a response message may be used, and the response massage may carry the information required by the AS. Main properties of the response message may be as shown in Table 2.

It should be noted that the units in the foregoing apparatus may be disposed or applied in the Radius server. Work modes of the units in the Radius server are the same as those in the foregoing apparatus, the description of which is omitted here.

The method embodiment and the corresponding apparatus embodiment shown in FIG. 2 use an example that a local user uses services. In practical applications, a terminal may use services at a roaming location. Therefore, the present invention further provides embodiments of a method and an apparatus for providing roaming user information.

The method for providing roaming user information includes the following steps. In a process when a terminal accesses a network, information for identifying a terminal is acquired. An authorization message and an accounting message are forwarded to a home Radius server of the terminal, and an associating relationship between the information for identifying the terminal and a network access identifier (NAI) is recorded. When a request for the user information from an AS is acquired, according to the information for identifying the terminal and provided by the AS and the recorded associating relationship between the information for identifying the terminal and the NAI, a home Radius server of the terminal is searched and user information associated with the information for identifying the terminal and provided by the home Radius server is acquired. The queried user information is provided for the AS. The process that the terminal accesses the network here means processes such as authorization and authentication between the terminal and the network, for example, a Radius AAA process. The information for identifying the terminal may be an IP address of the terminal. Of course, if the implementation environment permits, an identifier of the terminal may also be used as the information for identifying the terminal. The user information may include the user information acquired in the registration process of the terminal and the user information acquired in the process when the terminal accesses the network. The terminal may be a UE.

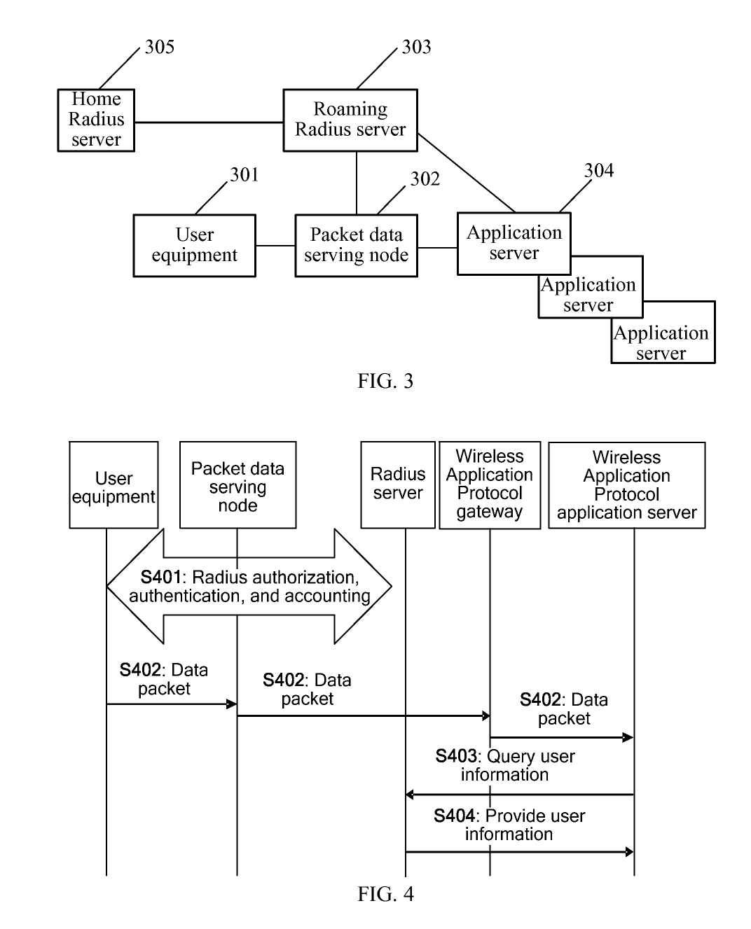

As shown in FIG. 3, a user-information querying interface is disposed between a roaming Radius server 303 and an AS 304. A user-information querying interface is dispose between the roaming Radius server 303 and a home Radius server 305. A bearer protocol used by the user-information querying interfaces may be the Diameter Protocol or the HTTP. Of course, the bearer protocol may also be other applicable protocols. The AS 304 is directly connected to a PDSN 302.

The home Radius server 305 may first acquire a part of user information through a registration process between the home Radius server 305 and the UE 301. The home Radius server 305 may acquire another part of the user information from the roaming Radius server 303. Specifically, the roaming Radius server 303 may acquire the other part of the user information in a Radius AAA process between the roaming Radius server 303 and the UE 301. Specifically, the roaming Radius server 303 acquires the user information from the acquired Radius accounting message reported by the UE 301.

When the UE 301 accesses through the PDSN 302, the roaming Radius server 303 provides a Radius authorization message and a Radius accounting message for the home Radius server 305 according to domain name management proxy rules. The home Radius server 305 records an associating relationship between an IP address of the UE 301 and the user information. The roaming Radius server 303 records an associating relationship between the IP address of the UE 301 and an NAI. The NAI may include a user name and a domain name.

When the UE 301 uses services, the UE 301 sends a data packet to the AS 304. If the UE 301 uses non-WAP services, the data packet does not need to pass through a WAP GW. If the UE 301 uses WAP services, the data packet needs to pass through the WAP GW (not shown) disposed between the PDSN 302 and the AS 304.

After the AS 304 receives the data packet, the AS 304 requests the user information through the user-information querying interface between the AS 304 and the roaming Radius server 303. The necessary information may be requested. Specifically, a request message may be used, and main properties of the request message are as shown in Table 1. The roaming Radius server 303 searches out an NAI associated with the IP address according to the IP address of the UE 301, and finds the home Radius server 305 according to a proxy rule corresponding to the domain name in the NAI. Subsequently, the roaming Radius server 303 requests the home Radius server 305 to provide the user information through the user-information querying interface between the roaming Radius server 303 and the home Radius server 305. It is possible that the information required by the AS 304 is provided. Specifically, a request message can be used, and main properties of the request message are as shown in Table 1. The home Radius server 305 queries user information associated with the IP address according to the IP address of the UE 301, and provides the user information for the roaming Radius server 303. Specifically, a response message may be used, and main properties of the response message are as shown in Table 2. Finally, the roaming Radius server 303 provides the user information for the AS 304. Specifically, a response message may be used, and main properties of the response message are as shown in Table 2.

It should be noted that in the foregoing method embodiment, the AS 304 does not need to differentiate whether the UE 301 is a local or roaming UE. The roaming Radius server 303 performs the differentiation.

The method for providing roaming user information may be implemented by apparatuses of various forms. One apparatus for providing roaming user information includes a terminal information acquiring unit, a report information forwarding unit, a recording unit, a request acquiring unit, a querying unit, a user information acquiring unit, and a user information providing unit. The terminal information acquiring unit is adapted to acquire information for identifying a terminal in a process when the terminal accesses the network. The report information forwarding unit is adapted to forward an authorization message and an accounting message reported by the terminal to a home Radius server of the terminal. The recording unit is adapted to record an associating relationship between the information for identifying the terminal and acquired by the terminal information acquiring unit and an NAI. The request acquiring unit is adapted to acquire a request for user information from an AS. The querying unit is adapted to search the home Radius server of the terminal, according to the information for identifying the terminal and provided by the AS, and the associating relationship between the information for identifying the terminal and the NAI and recorded in the recording unit. The user information acquiring unit is adapted to acquire user information associated with the information for identifying the terminal and provided by the home Radius server and queried by the querying unit. The associating relationship between the information for identifying the terminal and the user information is recorded by the home Radius server according to the authorization message and the accounting message forwarded by the report information forwarding unit. The user information providing unit is adapted to provide the user information acquired by the user information acquiring unit for the AS.

A user-information querying interface may be disposed between the request acquiring unit and the AS. A user-information querying interface may also be disposed between the user information acquiring unit and the home Radius server. Bearer protocols used by the two interfaces may be the Diameter Protocol or the HTTP. Of course, the bearer protocols may also be other applicable protocols.

When the terminal accesses through the roaming PDSN, the report information forwarding unit provides a Radius authorization message and a Radius accounting message for the home Radius server according to domain name management proxy rules. The home Radius server records an associating relationship between an IP address of the terminal and the user information. The recording unit records an associating relationship between the IP address of the terminal and the NAI. The NAI may include a user name and a domain name.

When the terminal uses services, the terminal sends a data packet to the AS. If the terminal uses non-WAP services, the data packet does not need to pass through a WAP GW. If the terminal uses WAP services, the data packet needs to pass through the WAP GW disposed between the PDSN and the AS.

After the AS receives the data packet, the AS requests the user information through the user-information querying interface between the AS and the request acquiring unit. It is possible that the necessary information is requested. Specifically, a request message can be used, and main properties of the request message are as shown in Table 1. The querying unit searches out an NAI associated with an IP address of the terminal according to the IP address, and finds a home Radius server according to a proxy rule corresponding to the domain name in the NAI. Subsequently, the user information acquiring unit requests to acquire the user information from the home Radius server through the user-information querying interface between the user information acquiring unit and the home Radius server. It is possible that the necessary information is requested. Specifically, a request message may be used, and main properties of the request message are as shown in Table 1. The home Radius server queries user information associated with the IP address according to the IP address of the terminal, and provides the user information for the user information acquiring unit. It is possible that the information required by the AS is provided. Specifically, a response message may be used, and main properties of the response message are as shown in Table 2. Finally, the user information providing unit provides the user information for the AS. It is possible that the information required by the AS is provided. Specifically, a response message can be used, and main properties of the response message are as shown in Table 2.

It should be noted that the units in the foregoing apparatuses may be disposed or applied in the roaming Radius server. Work modes of the units in the roaming Radius server are same as those in the foregoing apparatuses, the description of which is omitted here.

To facilitate persons skilled in the art to implement the present invention, several application embodiments of the present invention are illustrated in the following.

In a first embodiment, a local user uses a WAP service. As shown in FIG. 4, this embodiment includes the following steps.

In step S401, when UE accesses a network, a Radius AAA process is performed between the UE and a Radius server. The Radius server serves as an AAA server, which receives and processes a Radius authorization message and a Radius accounting message and records an associating relationship between an IP address of the UE and user information.

In step S402, when the UE uses services, the UE sends a data packet passing through a WAP GW to a WAP AS.

In step S403, the WAP AS sends a request message for querying user information to the Radius server through a user-information querying interface and provided by the Radius server.

In step S404, the Radius server queries corresponding user information according to the IP address of the UE, and provides the queried user information for the WAP AS.

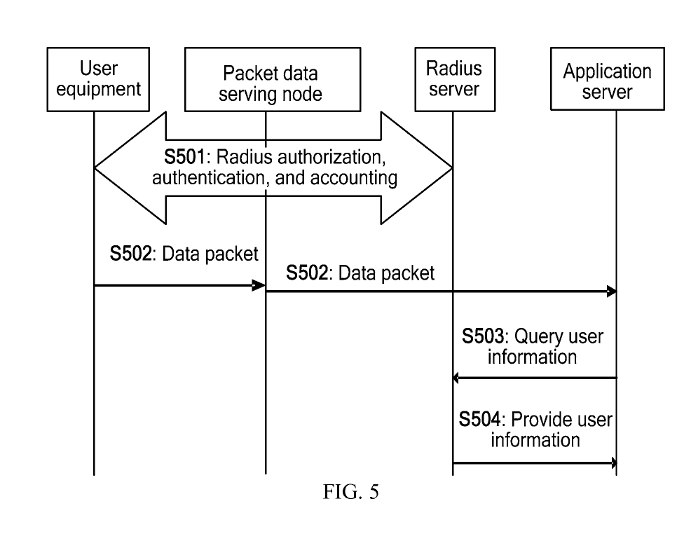

In a second embodiment, a local user uses non-WAP services. As shown in FIG. 5, this embodiment includes the following steps.

In step S501, when UE accesses a network, a Radius AAA process is performed between the UE and a Radius server. The Radius server serves as an AAA server, which receives and processes a Radius authorization message and a Radius accounting message and records an associating relationship between an IP address of the UE and user information.

In step S502, when the UE uses services, the UE sends a data packet to an AS. For a situation that the UE uses non-WAP services, the data packet does not need to pass through a WAP GW. Of course, network architecture providing non-WAP services may also include no WAP GW.

In step S503, the AS sends a request message for querying user information to the Radius server through a user-information querying interface and provided by the Radius server.

In step S504, the Radius server queries corresponding user information according to the IP address of the UE, and provides the queried user information for the AS.

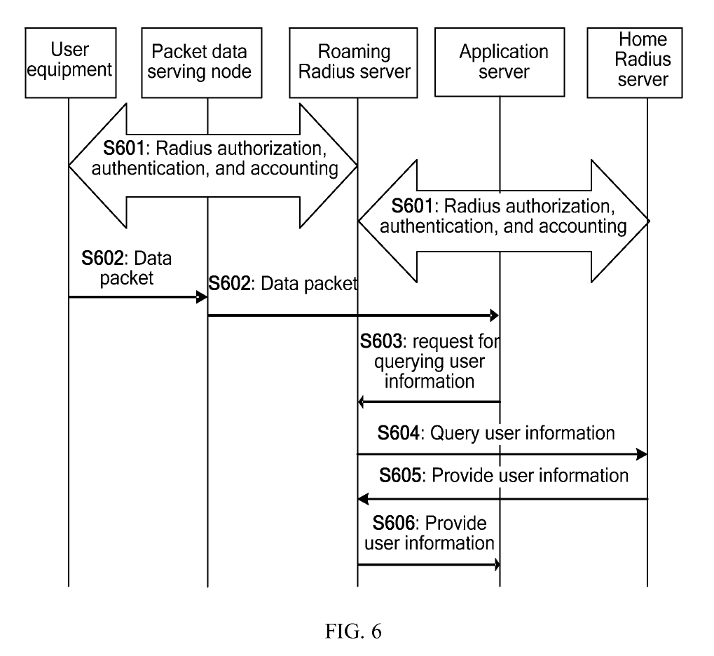

In a third embodiment, a roaming user uses non-WAP services. As shown in FIG. 6, this embodiment includes the following steps.

In step S601, when UE accesses a network in a roaming mode, a Radius AAA process is performed between the UE and a roaming Radius server. The roaming Radius server forwards a Radius authorization message and a Radius accounting message to a home Radius server of the UE according to domain name management proxy rules. The roaming Radius server needs to record an associating relationship between an IP address of the UE and an NAI. A format of the NAI may be a user name+a domain name. The home Radius server serves as an AAA server, which receives and processes the Radius authorization message and the Radius accounting message, and records an associating relationship between the IP address of the UE and user information.

In step S602, when the UE uses services, a data packet is sent to an AS. For a situation that the UE uses non-WAP services, the data packet does not need to pass through a WAP GW. Of course, network architecture providing WAP services may also include no WAP GW.

In step S603, the AS sends a request message for querying user information to the roaming Radius server through a user-information querying interface provided by the roaming Radius server.

In step S604, the roaming Radius server searches out an NAI according to the IP address of the UE, searches the home Radius server of the UE according to a domain name in the NAI, and sends the request message for querying the user information to the home Radius server through a user-information querying interface between the Radius servers.

In step S605, the home Radius server queries corresponding user information according to the IP address of the UE, and provides the queried user information for the roaming Radius server.

In step S606, the roaming Radius server provides the acquired user information for the AS.

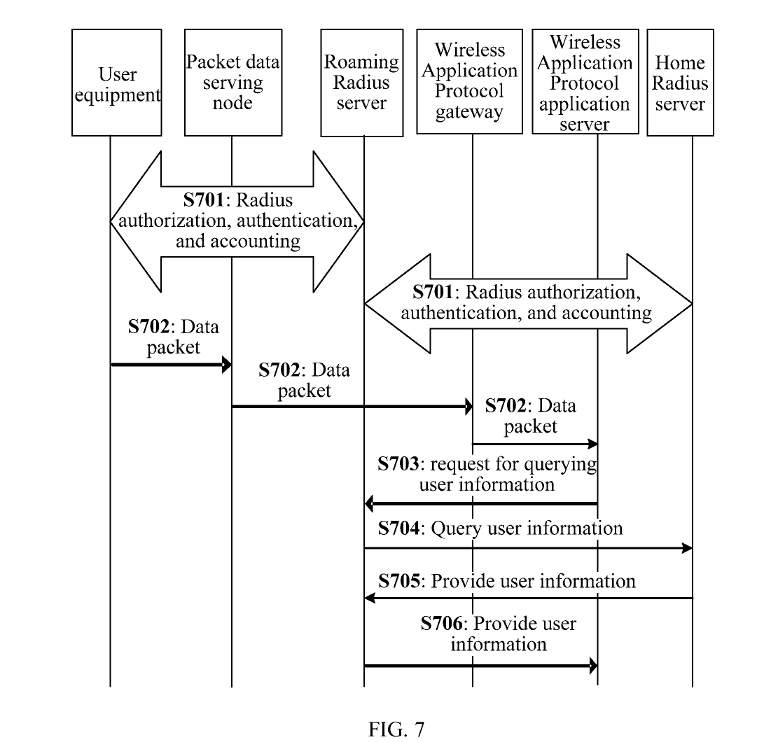

It should be noted that although in the third embodiment an example that the roaming user uses non-WAP services is used, if the AS is changed into a WAP server and a WAP GW is disposed between a PDSN and the WAP server, the third embodiment is also applicable in a situation that the roaming user uses WAP services. Specifically, as shown in the flow chart of FIG. 7, the fourth embodiment includes the following steps.

In step S701, when UE accesses a network in a roaming mode, a Radius AAA process is performed between the UE and a roaming Radius server. The roaming Radius server forwards a Radius authorization message and a Radius accounting message to a home Radius server of the UE according to domain name management proxy rules. The roaming Radius server needs to record an associating relationship between an IP address of the UE and an NAI. A format of the NAI may be user name+a domain name. The home Radius server serves as an AAA server, which receives and processes the Radius authorization message and the Radius accounting message, and records the associating relationship between the IP address of the UE and user information.

In step S702, when the UE uses services, the UE sends a data packet passing through a WAP GW to a WAP AS.

In step S703, the WAP AS sends a request message for querying user information to a roaming Radius server through a user-information querying interface and provided by the roaming Radius server.

In step S704, the roaming Radius server searches out an NAI according to the IP address of the UE, searches the home Radius server of the UE according to the domain name in the NAI, and sends the request message for querying the user information to the home Radius server through a user-information querying interface between the Radius servers.

In step S705, the home Radius server queries corresponding user information according to the IP address of the UE, and provides the queried user information for the roaming Radius server.

In step S706, the roaming Radius server provides the acquired user information for the WAP AS.

In the embodiments of the present invention, if services used by the terminal are non-WAP services, in practical implementation, the WAP GW adapted to provide the user information for the AS originally can be omitted, so as to save networking cost. At the same time, in the embodiment of the present invention, it is also realized that the roaming AS acquires the user information in a roaming scenario.

Persons of ordinary skill in the art should understand that all or a part of the steps of the method according to the embodiments may be implemented by a computer program instructing relevant hardware. The program may be stored in a computer readable storage medium. When the program is run, the steps of the method according to the embodiments are performed. The storage medium may be a magnetic disk, an optical disk, a read-only memory (ROM) or a random access memory (RAM).

Although the invention has been described through exemplary embodiments, the invention is not limited to such embodiments. It is apparent that those skilled in the art can make various improvements and refinements to the invention without departing from the spirit and scope of the invention. The invention is intended to cover the modifications and variations provided that they fall in the scope of protection defined by the following claims or their equivalents.

What is claimed is:

1. A method for providing user information, comprising:
acquiring, by a Radius server, a request for user information sent from an application server (AS) through a user-information querying interface between the Radius server and the AS;
querying user information associated with information for identifying a terminal, according to the information for identifying the terminal and provided by the AS, and a prerecorded associating relationship between the information for identifying the terminal and the user information; and
providing the queried user information for the AS.

2. The method for providing local user information according to claim 1, wherein before the acquiring the request for the user information from the AS, the method further comprises: acquiring the information for identifying the terminal in a process when the terminal accesses the network, and recording the associating relationship between the information for identifying the terminal and the user information.

3. The method for providing local user information according to claim 1, wherein the user information comprises user information acquired in a registration process of the terminal and user information acquired in a process when the terminal accesses the network.

4. The method for providing local user information according to claim 1, wherein a bearer protocol used by the user-information querying interface is a Diameter Protocol or Hypertext Transfer Protocol (HTTP).

5. An apparatus for providing user information, comprising:
a recording unit, adapted to record an associating relationship between information for identifying a terminal and user information;
a request acquiring unit, adapted to acquire a request for user information sent from an application server (AS) through a user-information querying interface;
a querying unit, adapted to query, after the request acquiring unit acquires the request, user information associated with the information for identifying the terminal, according to the information for identifying the terminal and provided by the AS, and the associating relationship, recorded in the recording unit, between the information for identifying the terminal and the user information; and
a providing unit, adapted to provide the user information queried by the querying unit for the AS.

6. The apparatus for providing local user information according to claim 5, further comprising an information acquiring unit, adapted to acquire the information for identifying the terminal in a process when the terminal accesses a network, and provide the information for identifying the terminal for the recording unit.

7. The apparatus for providing local user information according to claim 5, further comprising a registering unit, adapted to register with the terminal, acquire the user information through the registration, and provide the user information for the recording unit.

8. The apparatus for providing local user information according to claim 6, wherein the information acquiring unit acquires the user information in the process when the terminal accesses the network and provides the user information for the recording unit.

9. The apparatus for providing local user information according to claim 5, wherein the request for the user information from the AS acquired by the request acquiring unit is acquired through a user-information querying interface between the request acquiring unit and the AS, and a bearer protocol used by the interface is a Diameter Protocol or Hypertext Transfer Protocol (HTTP).

10. A method for providing roaming user information, comprising:
acquiring, by a roaming Radius server, a request for user information from an application server (AS) through a user-information querying interface between the roaming Radius server and the AS;
querying a home Radius server of a terminal, according to information for identifying the terminal and provided by the AS, and a prerecorded associating relationship between the information for identifying the terminal and a network access identifier (NAI), and acquiring user information associated with the information for identifying the terminal and provided by the home Radius server; and
providing the queried user information for the AS.

11. The method for providing roaming user information according to claim 10, wherein before the acquiring the request for the user information from the AS, the method further comprises: acquiring the information for identifying the terminal in a process when the terminal accesses a network, forwarding a Radius authorization message and a Radius accounting message to the home Radius server of the terminal, and recording the associating relationship between the information for identifying the terminal and the NAI.

12. The method for providing roaming user information according to claim 11, wherein the request for the user information from the AS is acquired through a user-information querying interface with the AS, the user information and provided by the home Radius server is acquired through a user-information querying interface with the home Radius server, and a bearer protocol used by the two interfaces is a Diameter Protocol or Hypertext Transfer Protocol (HTTP).

13. An apparatus for providing roaming user information, comprising:
a recording unit, adapted to record an associating relationship between information for identifying a terminal and a network access identifier (NAI);
a request acquiring unit, adapted to acquire a request for user information from an application server (AS) through a user-information querying interface;
a querying unit, adapted to search a home Radius server of the terminal, according to the information for identifying the terminal and provided by the AS, and the associating relationship, recorded by the recording unit, between the information for identifying the terminal and the NAI;
a user information acquiring unit, adapted to acquire user information associated with the information, provided by the home Radius server and queried by the querying unit, for identifying the terminal, wherein the associating relationship between the information for identifying the terminal and the user information is recorded by the home Radius server according to a Radius authorization message and a Radius accounting message; and
a user information providing unit, adapted to provide the user information acquired by the user information acquiring unit for the AS.

14. The apparatus for providing roaming user information according to claim 13, further comprising:
a terminal information acquiring unit, adapted to acquire the information for identifying the terminal in a process when the terminal accesses the network, and provide the information for identifying the terminal for the recording unit; and
a report information forwarding unit, adapted to forward the Radius authorization message and the Radius accounting message reported by the terminal to the home Radius server of the terminal.

15. The apparatus for providing roaming user information according to claim 13, wherein the request for the user information from the AS acquired by the request acquiring unit is acquired through a user-information querying interface between the request acquiring unit and the AS, the user information provided by the home Radius server and acquired by the user information acquiring unit is acquired through a user-information querying interface between the user information acquiring unit and the home Radius server, and a bearer protocol used by the two interfaces is a Diameter Protocol or Hypertext Transfer Protocol (HTTP).

16. A computer readable medium, comprising computer program code, which, when executed by a computer unit, will cause the computer unit to perform the steps:
acquiring a request for user information from an application server (AS) through a user-information querying interface;
querying user information associated with information for identifying a terminal, according to the information for identifying the terminal and provided by the AS, and a prerecorded associating relationship between the information for identifying the terminal and the user information; and
providing the queried user information for the AS.

17. A computer readable medium, comprising computer program code, which, when executed by a computer unit, will cause the computer unit to perform the steps:
acquiring a request for user information from an application server (AS) through a user-information querying interface;
querying a home Radius server of a terminal, according to information for identifying the terminal and provided by the AS, and a prerecorded associating relationship between the information for identifying the terminal and a network access identifier (NAI), and acquiring user information associated with the information for identifying the terminal and provided by the home Radius server; and
providing the queried user information for the AS.
